(19) United States
(12) Patent Application Publication
(10) Pub. No.: US 2015/0316408 A1
(43) Pub. Date: Nov. 5, 2015

(54) PORTABLE, HAND-HELD CONTROLLER AND INDICATOR TECHNOLOGY

(71) Applicants: William P. Kroll, Medina, MN (US); Matt Young, Golden Valley, MN (US)

(72) Inventors: William P. Kroll, Medina, MN (US); Matt Young, Golden Valley, MN (US)

(21) Appl. No.: 14/581,663

(22) Filed: Dec. 23, 2014

Related U.S. Application Data
(60) Provisional application No. 61/919,936, filed on Dec. 23, 2013.

(51) Int. Cl. G01G 23/32; B66C 13/16; B66C 13/44

(52) U.S. Cl. CPC G01G 23/32; B66C 13/44; B66C 13/16

(57) ABSTRACT

A portable, hand held device for controlling the operation of a crane or other device that includes weighing means, and for displaying or indicating weighing data in hand. The indicator includes a power source, a microcontroller communicatively connected to the power source, a radio module communicatively connected to the microcontroller, a display communicatively connected to the microcontroller, and a keypad. A system including the indicator and between one and four scales, and a crane control relay, is also disclosed.

### CROSS REFERENCE TO RELATED APPLICATIONS, IF ANY

This application claims the benefit under 35 U.S.C. §119(e) of co-pending U.S. Provisional Patent Application Ser. No. 61/919,936, filed Dec. 23, 2013, which is hereby incorporated by reference.

### 37 C.F.R. §1.71(E) AUTHORIZATION

A portion of the disclosure of this patent document contains material which is subject to copyright protection. The copyright owner has no objection to the facsimile reproduction by anyone of the patent document or the patent disclosure, as it appears in the US Patent and Trademark Office patent file or records, but otherwise reserves all copyright rights whatsoever.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

1. Field of the Invention

The present invention relates, generally, to electronic control and monitoring systems, apparatus and methods. Particularly, the invention relates to portable, hand held control and monitoring devices. Most particularly, the invention relates to a portable, hand held device for controlling the operation of a crane or other device that includes weighing means, and for displaying or indicating weighing data in hand.

2. Background Information

Existing technology in this field is believed to have significant limitations and shortcomings.

All US patents and patent applications, and all other published documents mentioned anywhere in this application are incorporated by reference in their entirety.

### BRIEF SUMMARY OF THE INVENTION

The present invention provides indication and control apparatus and methods which are practical, reliable, accurate and efficient, and which are believed to constitute an improvement over the background technology.

In one aspect, the invention relates to portable, hand held device for controlling the operation of a crane or other device that includes weighing means, and for displaying or indicating weighing data in hand.

In another aspect, the invention provides a portable controller and indicator comprising a power source, a microcontroller communicatively connected to the power source, a radio module communicatively connected to the microcontroller, a display communicatively connected to the microcontroller, and a keypad.

In yet another aspect, the invention provides A remote weighing system comprising:
a. at least two electronic scales each having a radio module; and
b. a portable controller and indicator for controlling and indicating the weight of the at least two electronic scales, the portable controller and indicator including:
(i) a battery power source,
(ii) a voltage regulator communicatively connected to the battery power source,
(iii) a microcontroller communicatively connected to the voltage regulator,
(iv) a radio module communicatively connected to the microcontroller,
(v) a 3.3 graphic LCD display communicatively connected to the microcontroller, and
(vi) a keypad: and
c. whereby the portable controller and indicator provides at least a single scale weight and an accumulated scale weight of multiple weighings of the at least two remote electronic wireless communicating scales on the display simultaneously.

And a further aspect of the invention provides A method of remotely controlling and indicating the weight of an object or article, comprising the steps of:
a. providing at least two electronic scales each having a radio module;
b. providing a portable controller and indicator for controlling and indicating the weight, of the at least two electronic scales, the portable controller and indicator including:
   (i) a battery power source.
   (ii) a voltage regulator communicatively connected to the battery power source,
   (iii) a microcontroller communicatively connected to the voltage regulator,
   (iv) a radio module communicatively connected to the microcontroller.
   (v) a 3.3 graphic LCD display communicatively connected to the microcontroller, and
   (vi) a keypad;
c. communicatively coupling at least one object or article to each of scales;
d. weighing the at least one object or article at each scale; and
e. establishing a radio frequency communication link between the using the portable controller and indicator and each scale, whereby the portable controller and indicator provides at least a single scale weight and an accumulated scale weight of multiple weighings of the at least two remote electronic wireless communicating scales on the display simultaneously.

The present invention is believed to involve novel elements, combined in novel ways to yield more than predictable results. The problems solved by the invention were not fully recognized in the prior art.

The aspects, features, advantages, benefits and objects of the invention will become clear to those skilled in the art by reference to the following description, claims and drawings.

### BRIEF DESCRIPTION OF THE SEVERAL VIEWS OF THE DRAWING

FIG. 1 is a perspective view of an embodiment of the hand held indicator and controller of the present invention, including a 3.3 in LCD graphic display.

FIG. 2 is a front view of the embodiment of the indicator-controller,

FIG. 3 is an front view of embodiment of the indicator-controller screen showing a first display mode, namely a single weight of a scale.

FIG. 4 is a view of the screen showing a second display mode, including a single scale weight and a total accumulated weight from multiple weighings of the scale,

FIG. 5 is a view of the screen showing third mode with readings of four scales simultaneously, including total, gross, net, tare and peak.

FIG. 6 is a top view of an embodiment of the circuitry of the indicator-controller including a calibration strap.

FIG. 7 is a perspective view of an alternative embodiment of the display, namely a 2×16 character LCD type, and keypad.

FIG. 8 is front view of the controller indicator embodiment of FIG. 7,

FIG. 9 is a perspective view of a tension link crane scale useable with the indicator-controller or as part of a complete system.

FIGS. 10A-C, 11A-D, 12A-B, 13A1-B, 14A1-B2 and 15A-B are circuit schematics of an embodiment of the circuitry of the indicator-controller.

FIG. 16 is a table of menu options.

FIG. 17 is a table of pad status error messages.

### DETAILED DESCRIPTION

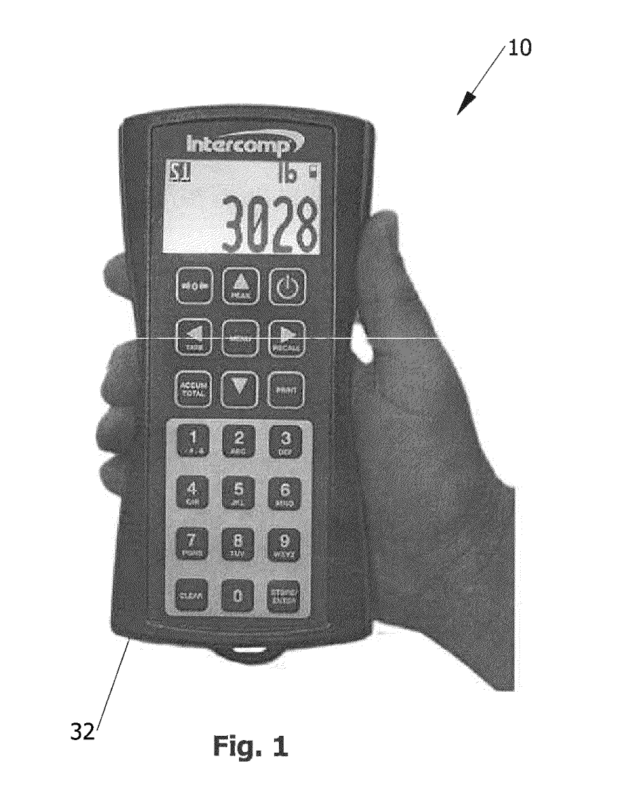

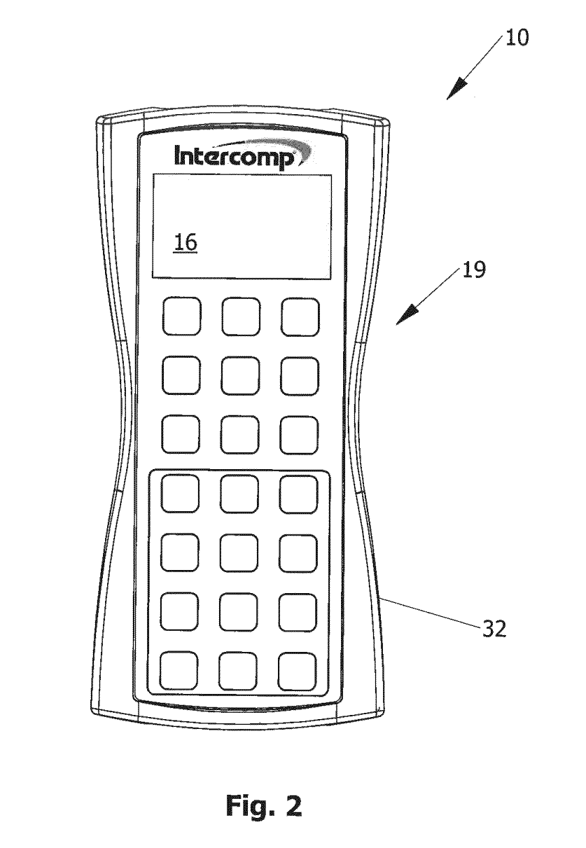

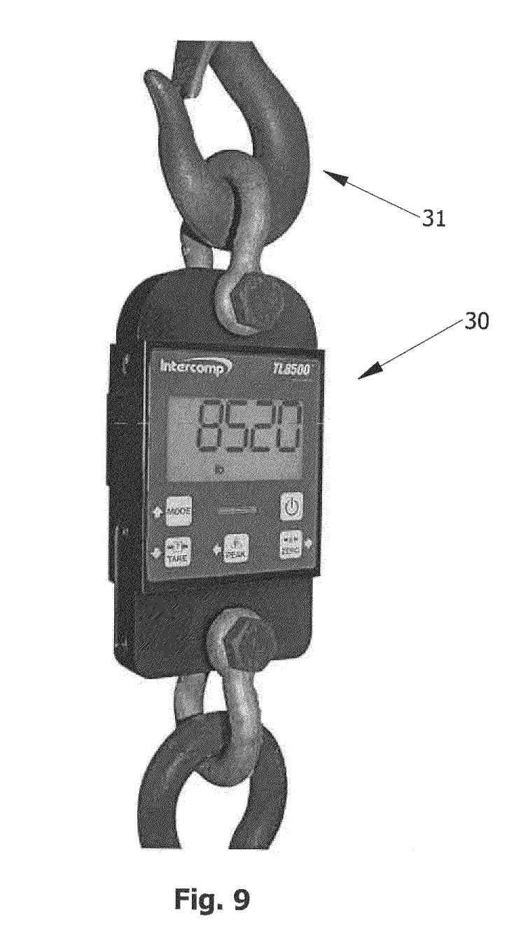

Referring to Figures 1, 2 and 9, the present invention provides a hand held indicator-controller device, a system including the hand held indicator-controller device 10 and one or more remote wireless communicative scales 30 (and optionally a crane control module for a crane 31), and method of using the indicator controller 10 with scales 30 alone or the scales 30 and crane 31. The indicator-controller further permits efficient monitoring of weigh data from the scales 30. The indicator-controller and system are useable with up to four (4) scales 30. Exemplary scales that the indicator 10 is useable with to provide remote indication are Tension Link Crane Scales such as the TL850G (See FIG. 9) and TL8000 provided by Intercomp Company of Minneapolis, Minn. USA. These crane scales have weighing capacities between 500 to 500,000 pounds (250 to 25,000 kg). The indicator-controller 10 is communicatively linkable to a relay control connected to the crane to control the crane (or other devices) to which the scales are coupled.

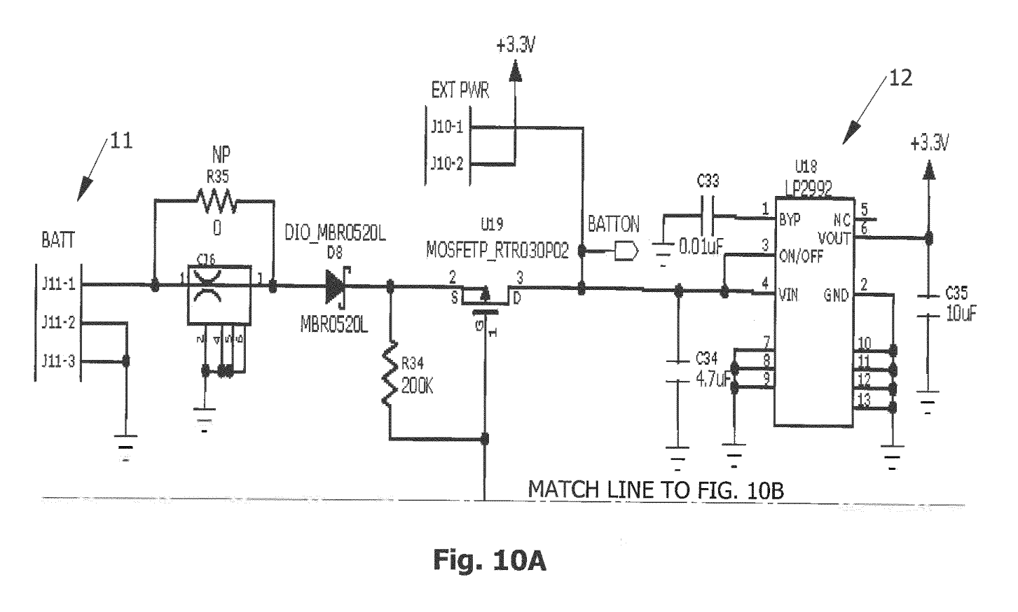

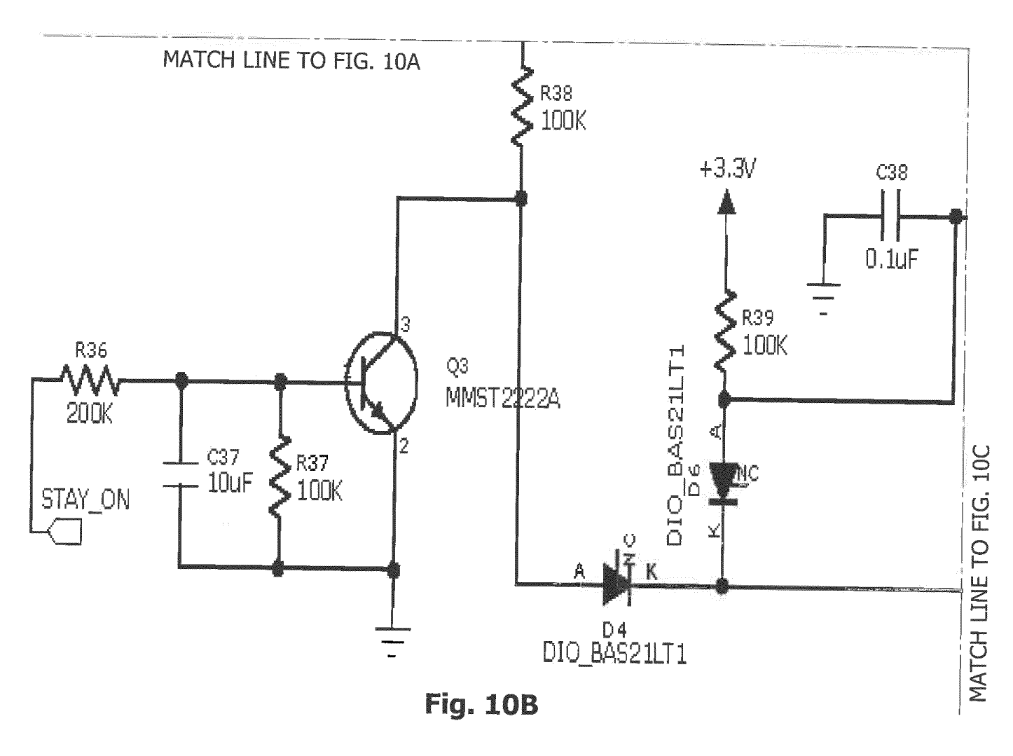

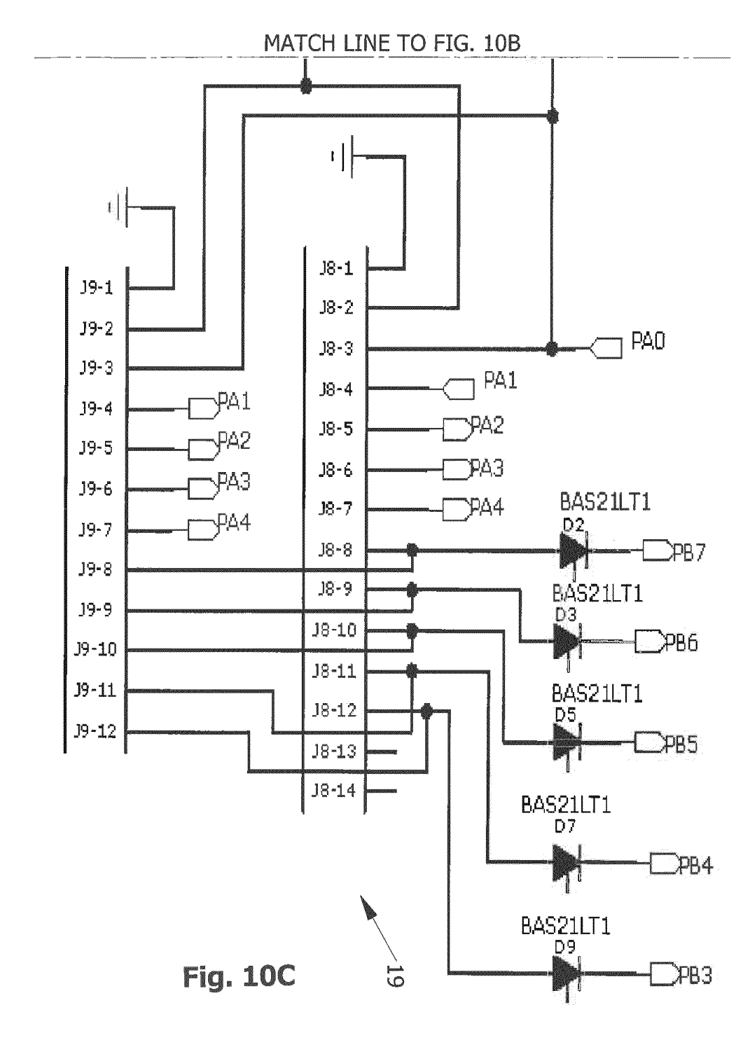

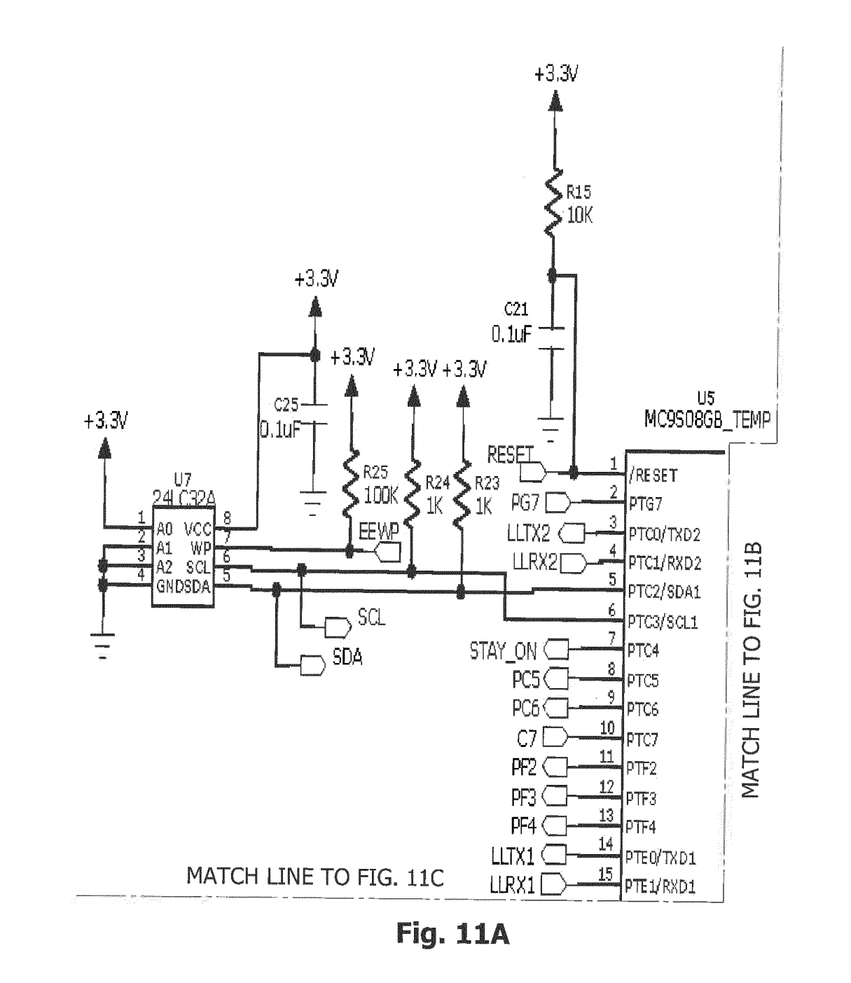

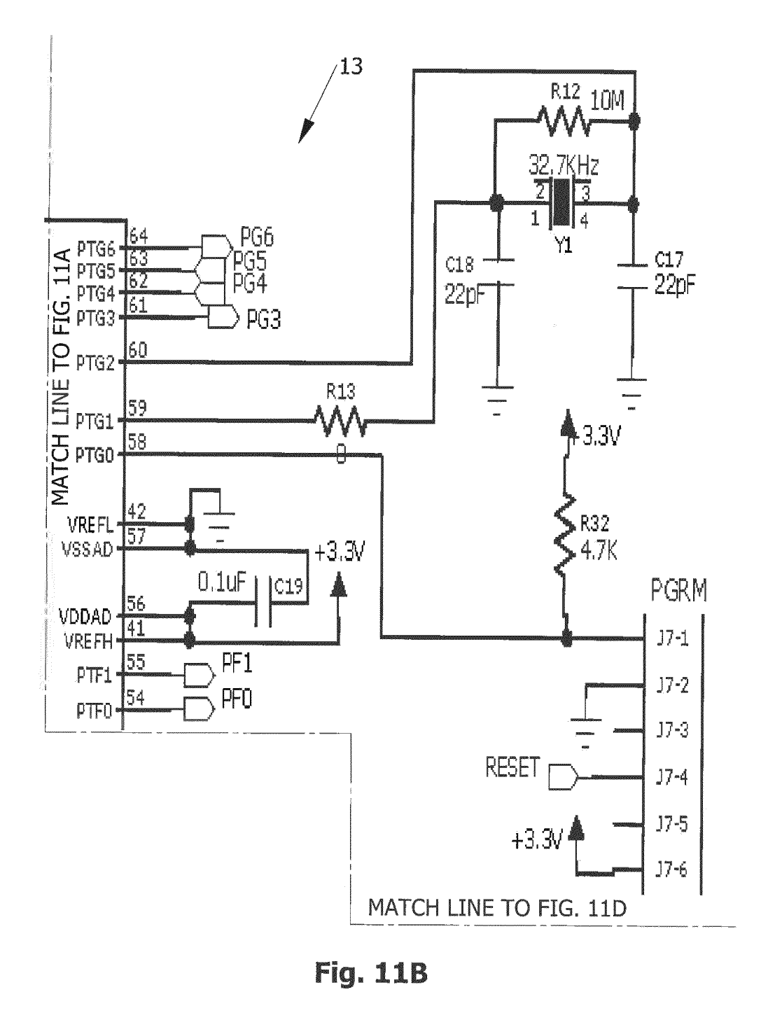

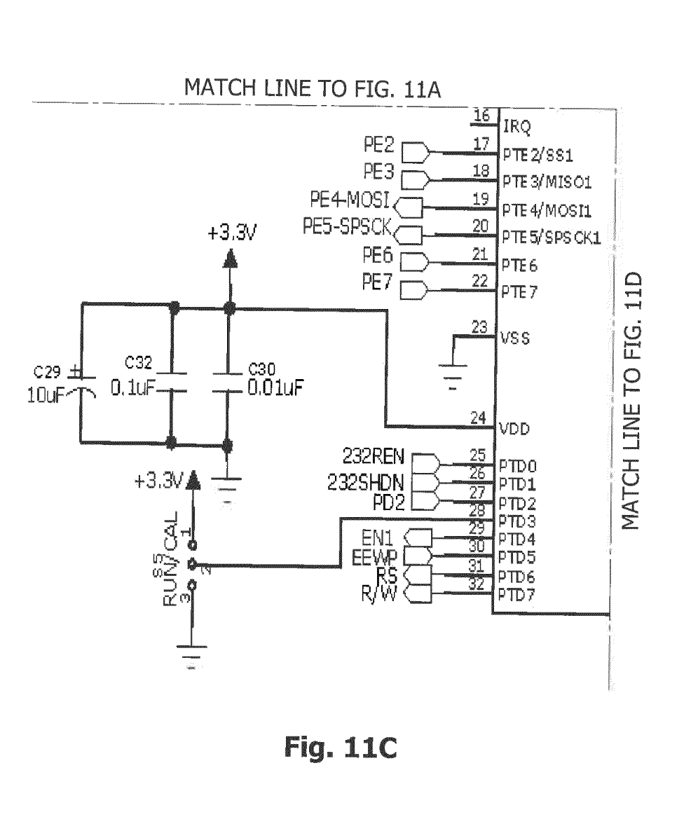

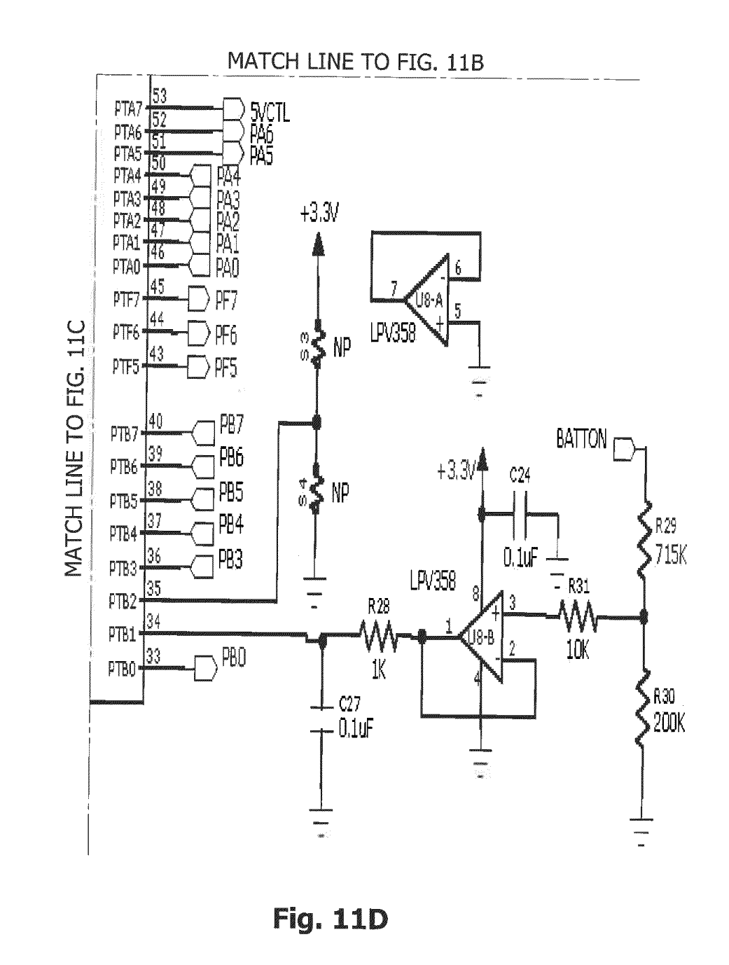

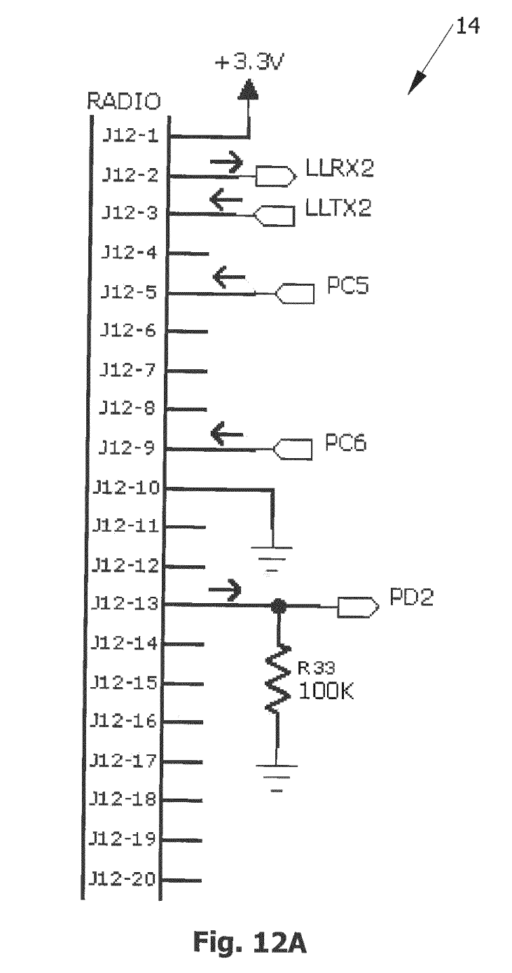

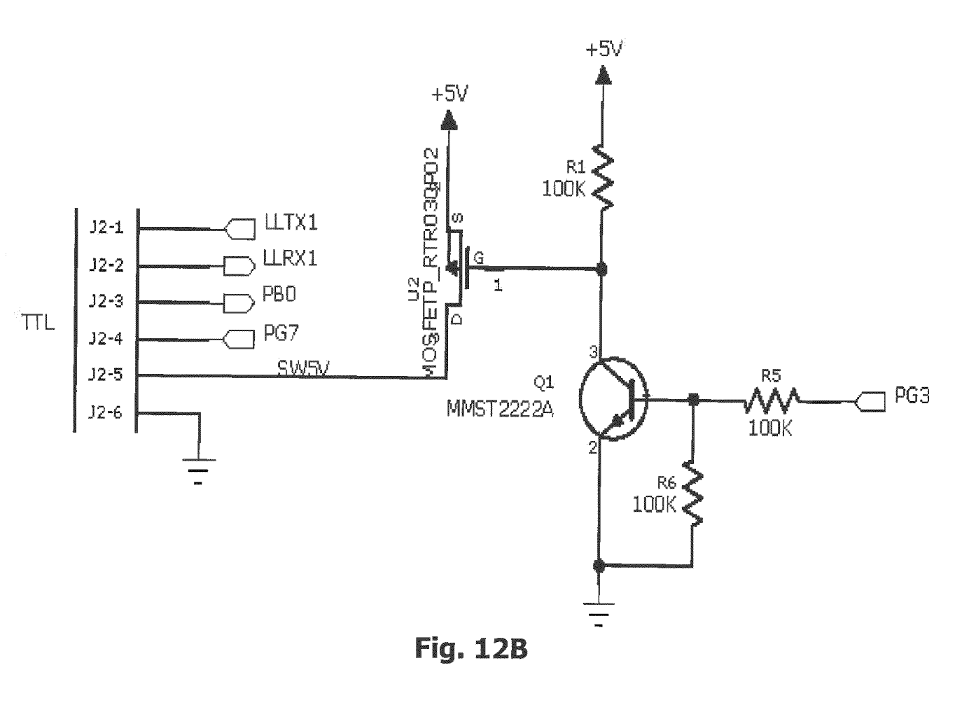

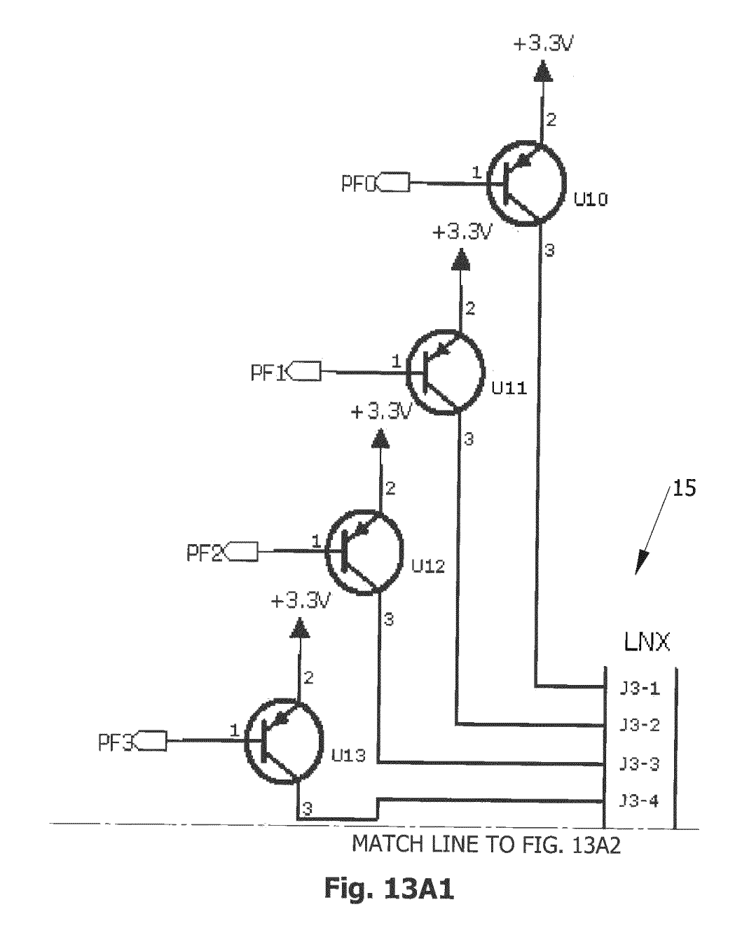

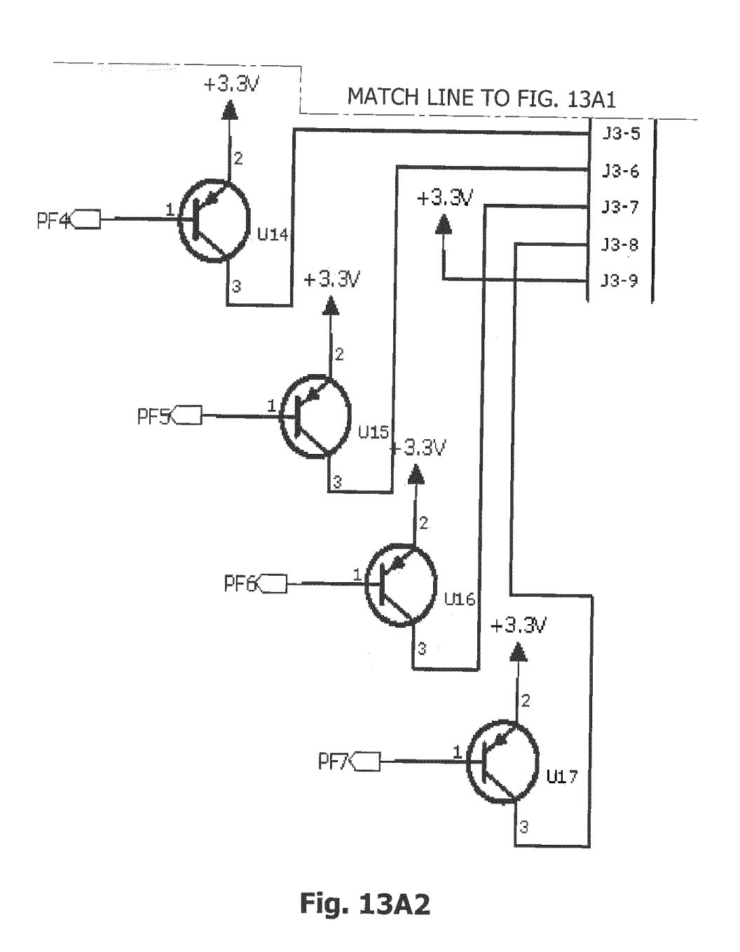

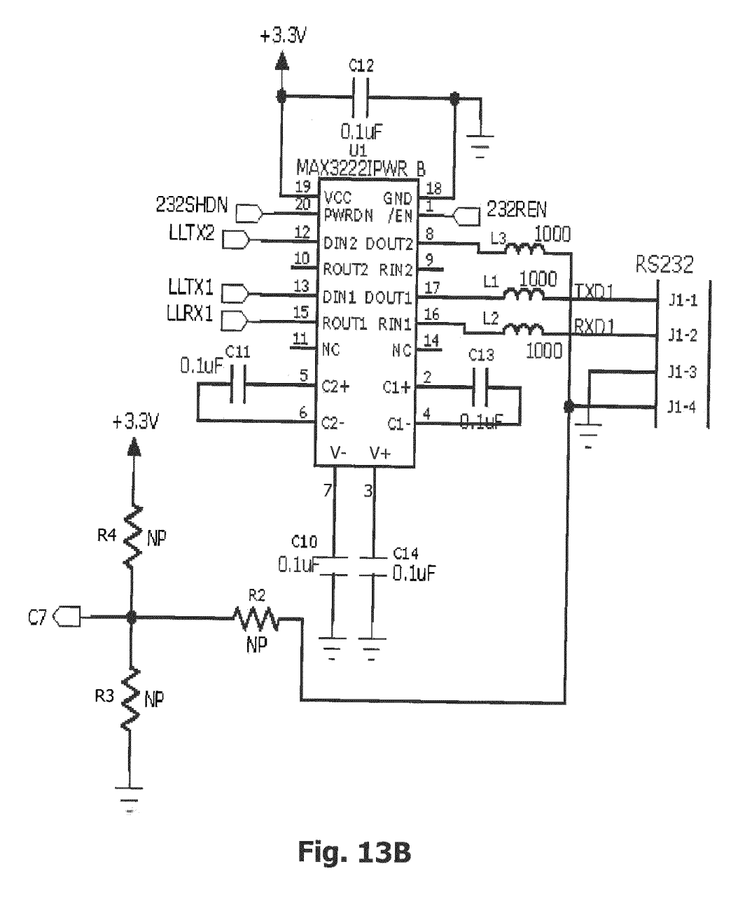

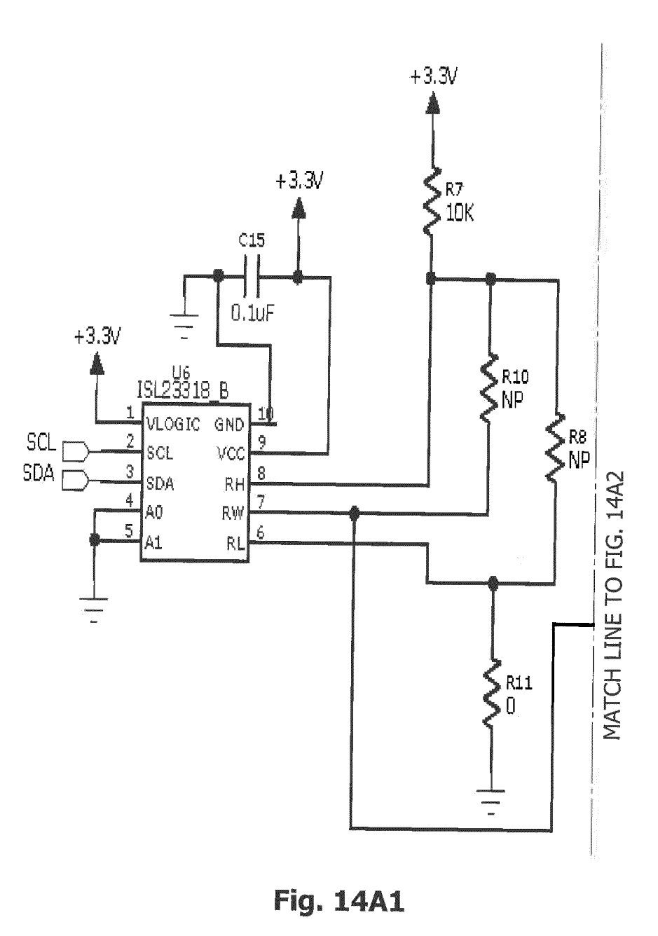

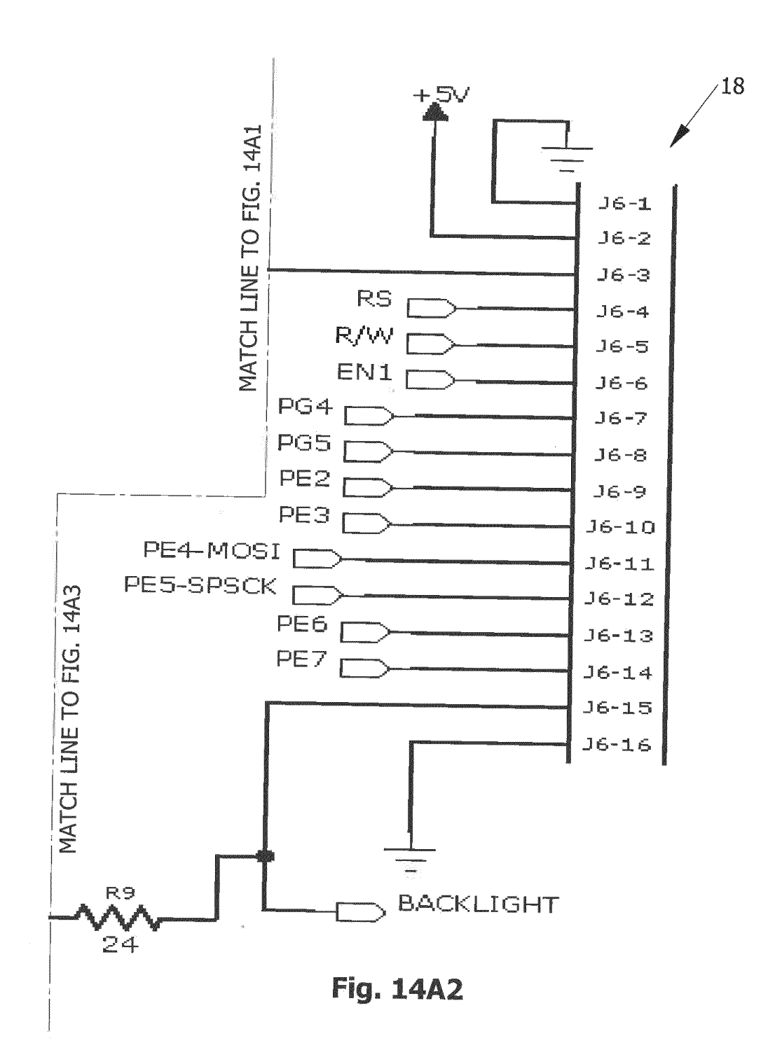

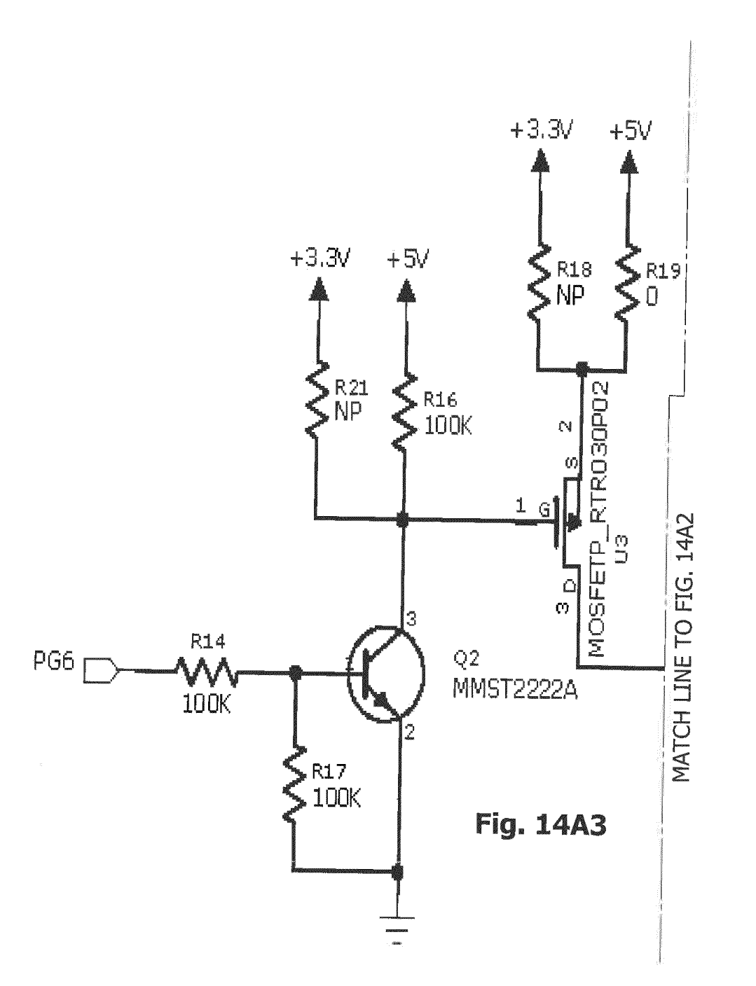

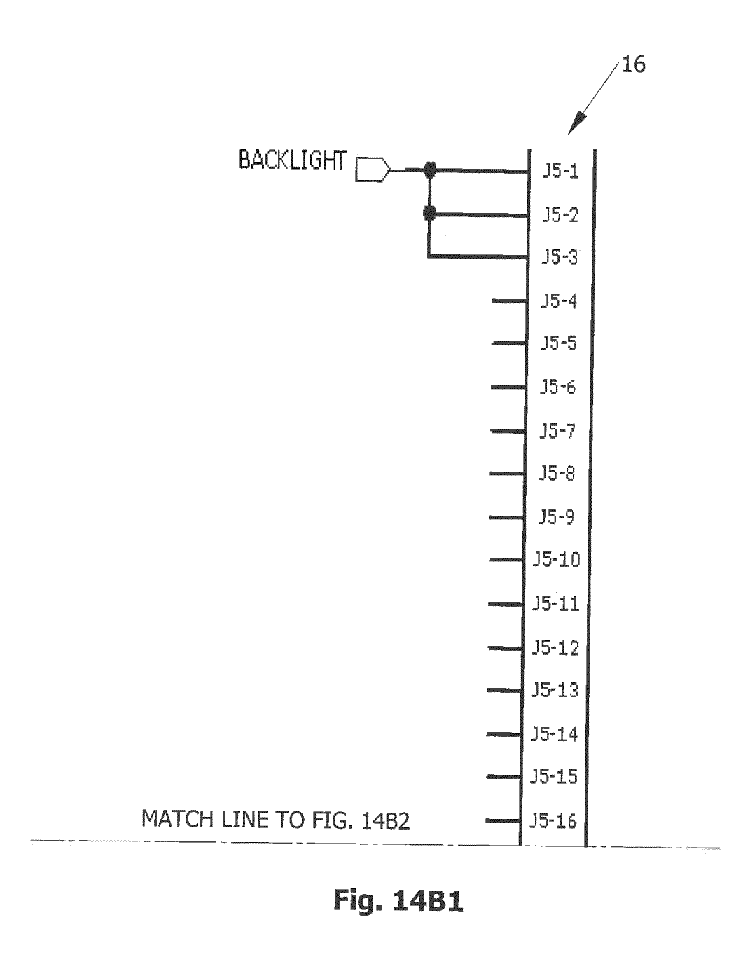

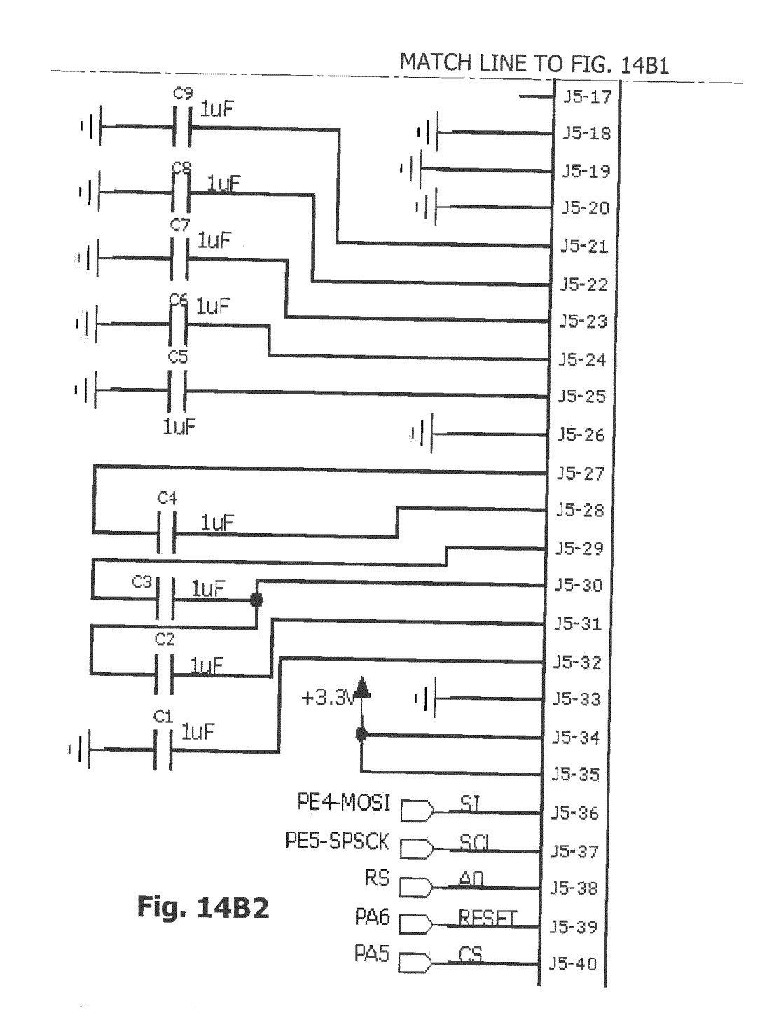

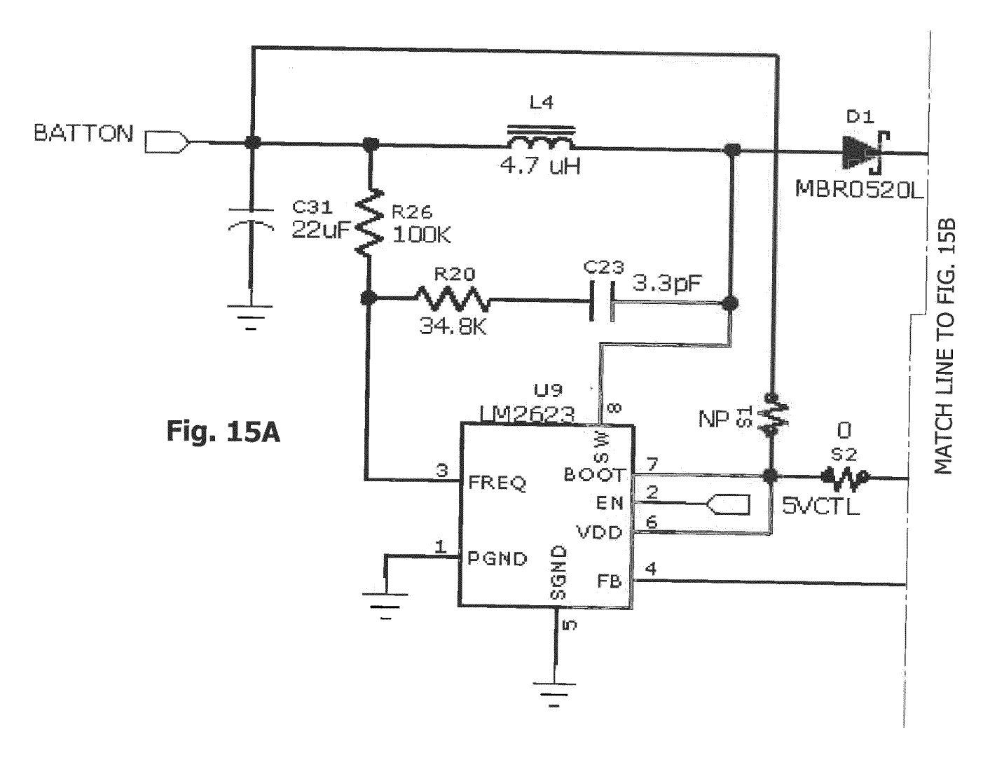

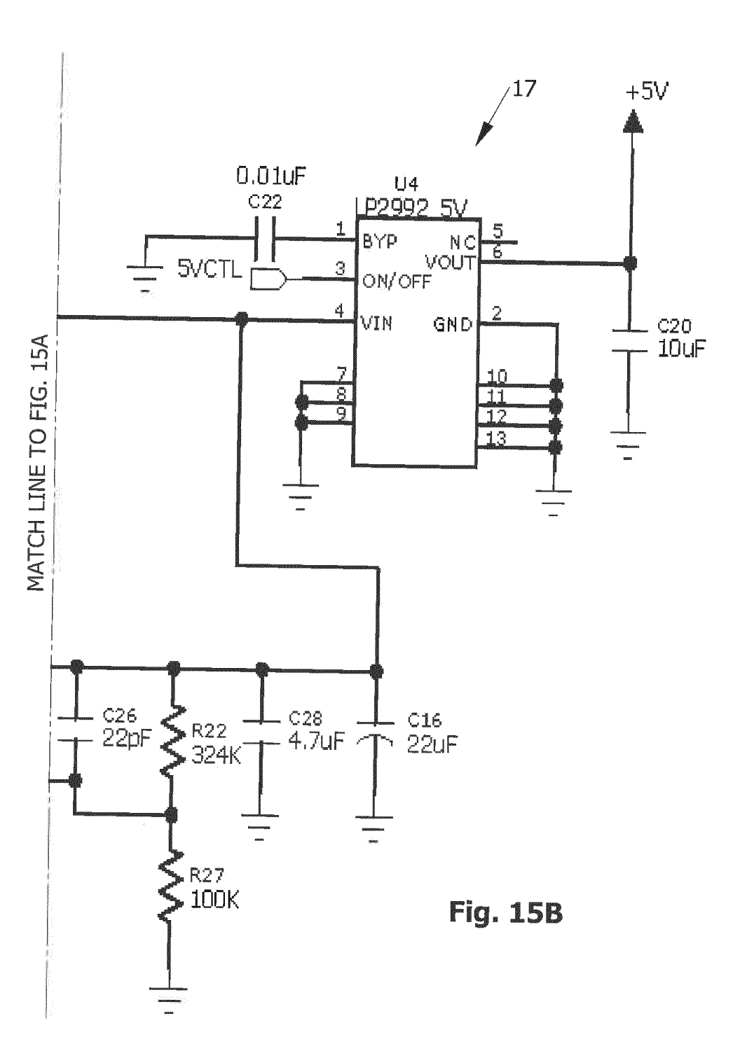

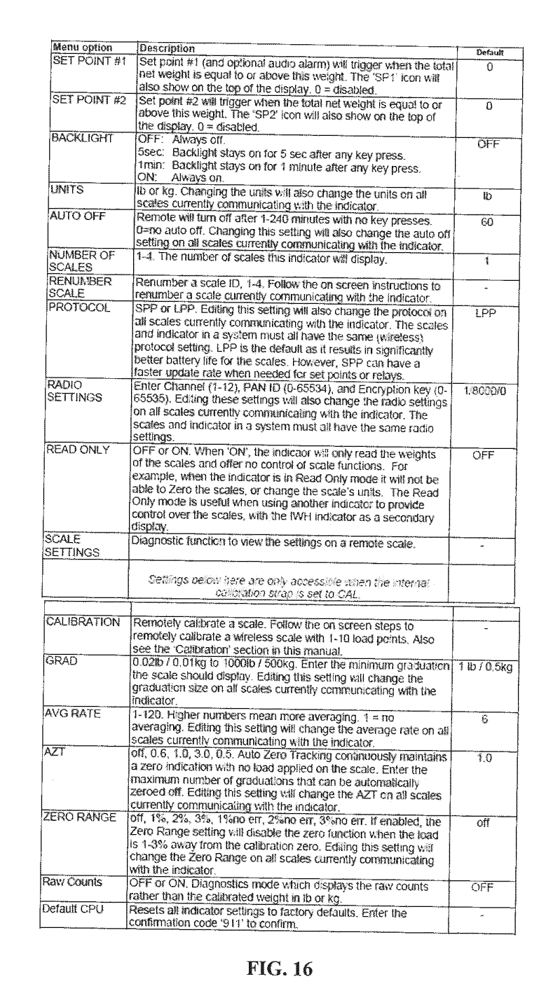

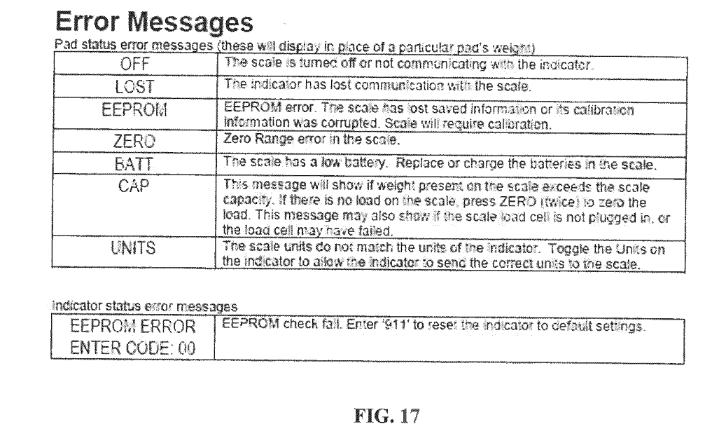

Referring also to Figures 10A-C, 11A-D, 12A-B, 13A1-B, 14A1-B2 and 15A-B, the device 10 has the following buttons or keys on the front face thereof: a Display 16, a Power button, Zero button, Peak/UP combination button, Tare/LEFT button, Recall/RIGHT button, DOWN MENU button, Accum/Total button. Print button, Clear button, Store/Enter button, and a numeric (0-9) keypad. The display 16 is preferably a 3.3 in (measured diagonally) Graphic LCD display with a backlight. The device 10 is preferably powered by batteries 11, for example 4× AA alkaline batteries. In the embodiment shown and described herein, battery Life is approximately 40 hours, with backlight off, and 32 hours, with backlight on. The device 10 is capable of power up to 180 hours in SPP protocol mode. However, SPP mode is not recommended for most systems because it may reduce the battery life of the scales.

Physically, the exemplary device 10 embodiment has dimensions 3.5 in×1.6 in (97 mm×40 mm×210 mm). The device weight is 15 oz (430 g) IP: IP65 Environmental operating conditions include humidity range of 10 to 95% non-condensing, and temperature range: Storage: −30° C. to +70° C./−22° F. to +158° F. and Operating: −10° C. to +60° C./14° F. to +140° F.

The device radio specifications of the exemplary embodiment are preferably as follows: (1) Radio Frequency: ISM 2.4 GHz, 802.15.4, DSSS*, (2) License Requirements: None. Pre-approved US/FCC, CAN/IC, EUR/CE, and (3) Range: 200′/60 m indoor, 300′/90 m line of sight. Frequency: ISM 2.4 GHz (2.400 GHz 2.483 GHz), with 12 channels (CH 112) within that range with each center frequency=2405 MHz+(CH*5) MHz Power output 63 mW (18 dBm), 10 mW (10 dBm) for international variant. Antenna is internal surface mount with −1.5 dbi gain, omnidirectional.

In a preferred embodiment, the function of each key/button is described in more detail as follows:

Power: Press the Power key to cycle the indicator power on or off.

Zero: This will zero all scales, Press ZERO, and a confirmation screen will appear. Press ZERO gain to confirm zeroing all scales.

Peak: Press PEAK to toggle PEAK mode. When PEAK is enabled, the (peak) weight will show the highest total net weight registered by the scale. A ‘P’ icon will show along the top of the display when peak is enabled.

Tare: Press TARE to enter a tare weight using the keypad. Whenever there is a tare weight, the display will add lines for G(Gross), T9Tare), and N(Net). Press TARE and ZERO together to clear tare.

Menu: Press MENU to enter or exit the options menu. See ‘MENU’ section for more details.

Recall: This key is reserved for future use.

Accum Total: Press ACCUM TOTAL to accumulate the current total net weight to the accumulated total weight. The weight must be a positive value to accumulate. The weight must return to zero in between successive accumulations. Whenever there is an accumulated total, the display will add an “ACCUM #” line that shows the number of weights that were accumulated plus the total accumulated weight. Press ACCUM TOTAL and ZERO together to clear the accumulated total.

Numeric keypad (0-9), CLEAR, and STORE/ENTER: The numeric keypad (09) is used when entering numbers. When entering a number, press CLEAR to clear the entry. When the desired number is showing, press STORE/ENTER to save the value.

Adjust contrast. The arrow keys can be used to adjust LCD contrast. While holding the LEFT key, repeatedly press UP or DOWN to adjust the contrast up or down.

Print. Press PRINT to print to an optional wireless printer. The printout will contain the same weight data that is shown on the display when PRINT is pressed. As with the main display, only lines that are being used will be included on the printout. Here is an example of a printout with all possible lines showing:

| | |
|---|---|
| 1: 3014 lb | |
| 2: 5997 lb | |
| 3: 2000 lb | |
| 4. 3000 lb | |
| TOTAL: | 14011 lb |
| GROSS: | 14011 lb |
| TARE | 1000 lb |
| NET: | 13011 lb |
| PEAK | 14011 lb |

| | |
|---|---|
| ACCM# 01: | 28040 lb |

When using the RFX TS232 Module for wireless printing, set the following settings on the module. PRINTMODE DEMAND, READONLY YES. Everything else set to match system.

In a preferred embodiment the method of operating the device 10 and system (including indicator-controller 10 and one or more scales 30) is as follows:

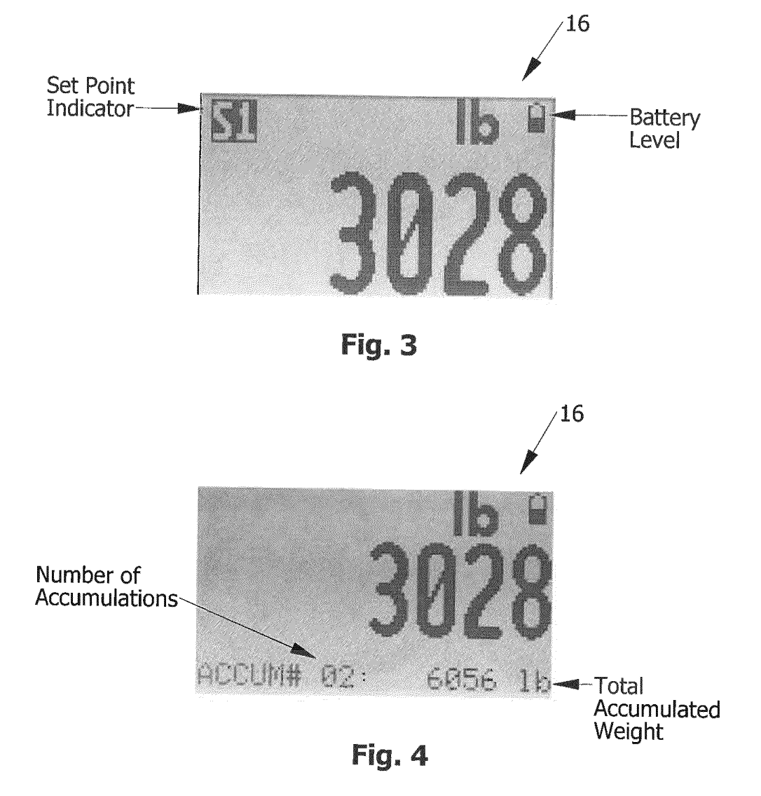

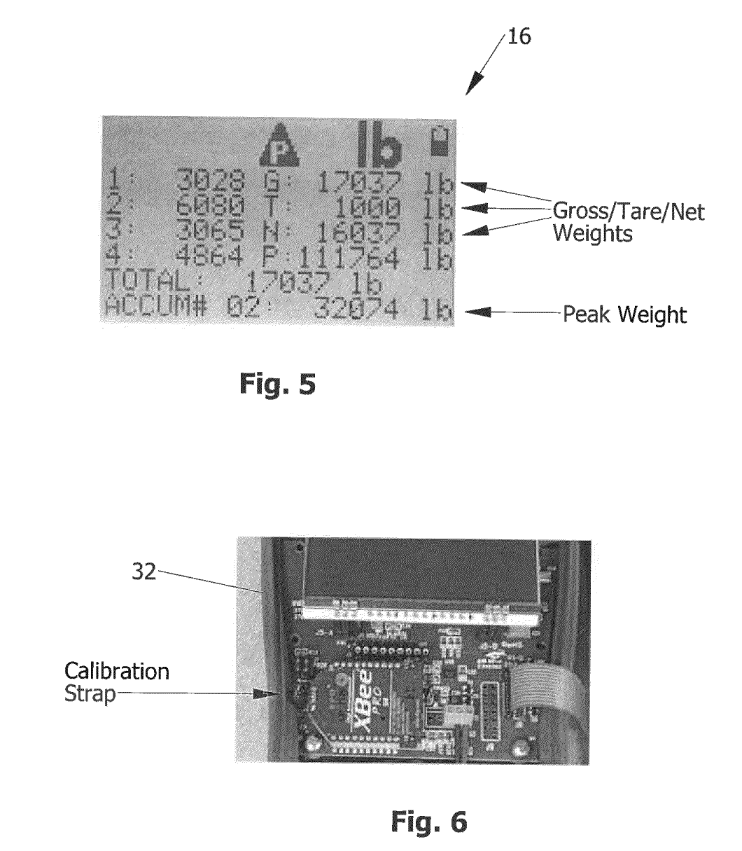

Displays. There are 3 main display types on the IWH indicator: Large, Medium, and Multi-line format. The display type is determined automatically. Referring to FIG. 3, the Large Display will show when there is one scale with no tare weight or accumulated total Referring to FIG. 4, the Medium Display will show when there is one scale with an accumulated total, but no tare weight. Referring to FIG. 5, the Multi-line Display will show when there is more than one scale (up to four) or there is a tare weight.

Menu Options. Press MENU to access the menu options, Press the UP and DOWN arrow keys to cycle through the available menu options. When viewing an option, press STORE/ENTER to edit that setting. If editing a number, then use the numeric keypad to enter a new value and press STORE/ENTER to save. Press MENU again to exit the menu options. Calibration options are also in this menu, but they are only accessible when the RUN/CAL strap Inside the indicator is set to CAL. Menu options are further described in the following Table.

Relay Outputs. The indicator has a wireless output that will interface with an optional wireless relay board. Relays #1 and #2 are controlled with by setpoint #1 and #2. Relays #3 #6 are direct controlled by pressing keys 3-6 on the keypad,

Calibration. To access the calibration menu, the calibration strap must be moved from the “RUN” to the “CAL” position. Referring to FIG. 6, access the calibration strap as follows: (1) Remove the four screws on the back of the indicator. (2) Carefully separate the indicator top from the base, ensuring that the ribbon cable does not come off of the board. (3) Move the strap that is shown below to the “cal” position. (4) Reattached the top of the indicator to the base. Return the cal strap to the RUN position after finishing calibration to prevent accidental entry in the calibration section.

Calibrate Scale. With the RUN/CAL strap set to CAL, press MENU to access the menu options. Press the DOWN arrow key to advance to ‘CALIBRATION’ and then press STORE/ENTER. The calibration routine will prompt the user through the calibration of the scale and can accommodate a 1 10 point calibration. The scale's calibration strap must also be set to “CAL” position. Refer to the individual scale's user manual for access to the scale's calibration. The process that the operator will be prompted through is as follows: (1) Enter the scale number; (2) Enter the number of cal points; (3) Remove weight and enter the capacity of the scale Note: The scale can accept any weight within its range. The weights must be entered and placed on the scale from the lowest weight to the greatest weight that will be applied: (4) Place the first cal weight on the scale; (5) Repeat step 4 until all calibration points have been completed. (6) After the last calibration point, the display will return normal operations. Cycle power on the scale just calibrated before testing.

Regarding power, this indicator preferably uses four ‘AA’ batteries. Alkaline or NiMH rechargeable are most preferred. A battery icon at the top right of the display show's the approximate battery level of the indicator when using alkaline batteries. To replace batteries, remove the two screws on the back of the indicator to gain access to the batteries. Install new batteries with attention to polarity and replace the battery cover.

Pad status errors are indicated as shown in the following Table.

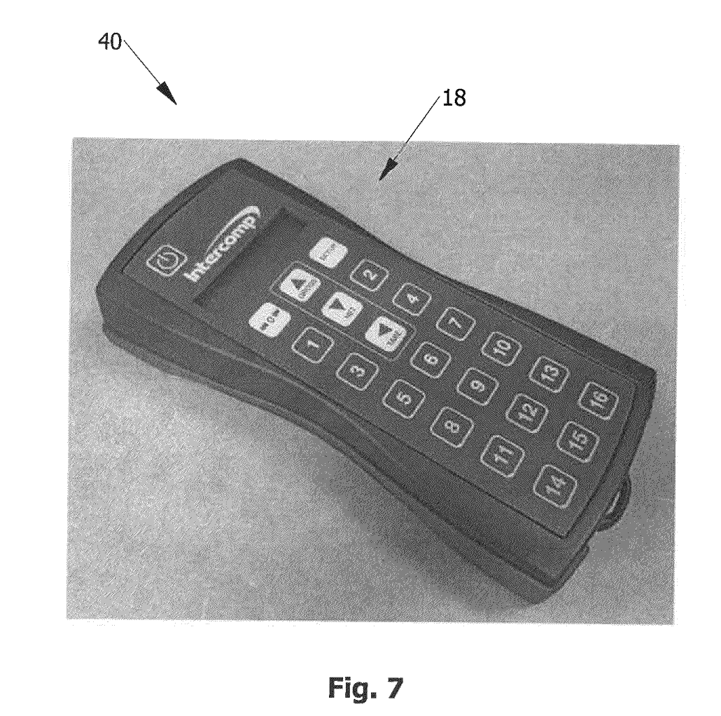

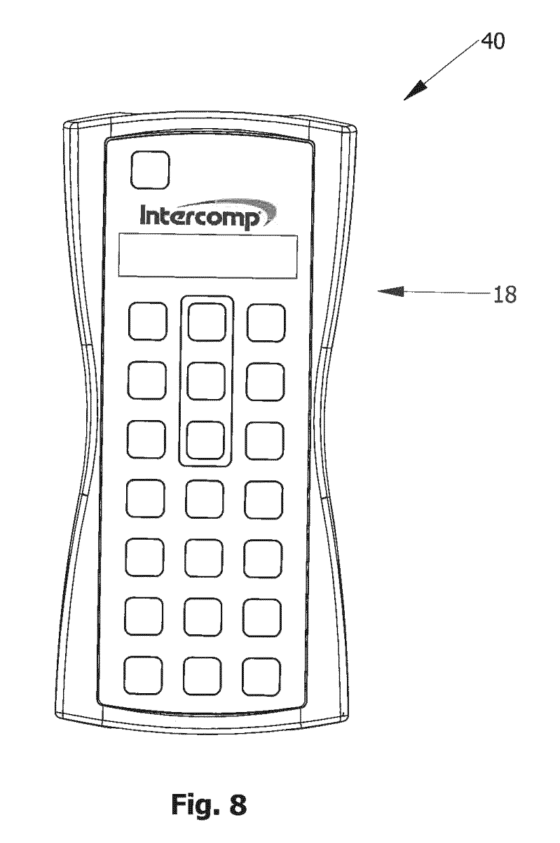

FIGS. 10A-C, 11A-D, 12A-B. 13A1-B, 14A1-B2 and 15A-B show embodiments of circuitry for the indicator controller. The STR board is the circuit board inside the housing 32 of the hand held indicator-controller device 10. Referring first to FIGS. 10A-C and 11A-D, the components of the STR board include a power input connection 11, a 3.3 V voltage regulator 12, a microcontroller 13 and a keypad input connection 19. Referring also to FIGS. 12A-B, an 802.15.4 radio module 14 is communicatively coupled to these components. FIGS. 13A1-B shows a 900 MHz radio module 15 that may alternatively be used. Referring next to FIGS. 14A1-B2, the device 10 preferably includes a 3.3 in graphic LCD display 16. Alternatively a 3×16 character LCD display 18 may be used (for example as shown in the device 40 of FIGS. 7 and 8. Further, the device 10 preferably includes a 5V step-up supply 17 shown in FIG. 15B.

The STR board accepts battery power at the input power connector 11, which then runs to the voltage regulator 12 which provides 3.3V. This 3.3V supply in turn powers the microcontroller 13, the 802.15.4 radio module 14, the 900 MHz radio module 15, the 3.3 in graphic LCD display 16, and the 5V step-up circuit 17. The 5V supply powers the 2×16 character LCD display 18 and the backlight for both displays 16 and 18. The user interface is controlled by a keypad connected at connection 19, and viewed with either the 2×16 character display 18 or the 3.3 in. graphic display 16, depending on product version.

The STR board uses the 802.15.4 radio module 14 to communicate wirelessly to a separate wireless scale module and a separate wireless relay module. The STR board receives weights from the scale module and shows them on the LCD display (16 or 18). The STR board receives user control commands via the keypad input 19, and then transmits those commands via 14 to the external relay module. Depending on product version, an alternative relay control method may be used. In this case the STR board transmits those commands via the 900 MHz radio module 15, which controls an external 900 MHz relay receiver module.

The microcontroller 13 is preferably a MC9S08GB60A, available from Freescale. This microcontroller 13 is a high performance 8-bit controller and provides extended battery life with maximum performance

FIGS. 7 and 8 show an alternative embodiment of the indicator 40 which has the 2×16 character display 18.

The embodiments above are chosen, described and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

The invention claimed is:

1. A portable controller and indicator comprising a power source, a microcontroller communicatively connected to the power source, a radio module communicatively connected to the microcontroller, a display communicatively connected to the microcontroller, and a keypad.

2. The portable controller and indicator of claim 1, tor controlling and indicating the weight of at least one remote electronic, wireless communicating scale via radio frequency signals.

3. The portable controller and indicator of claim 2, wherein the at least one remote electronic, wireless communicating scale is a tension link crane scale.

4. The portable controller and indicator of claim 3, tor further controlling a crane to which the tension link crane scale is connected to the portable controller and indicator communicating with a wireless relay control communicatively connected to the crane.

5. The portable controller and indicator of claim 2, wherein four (4) remote, electronic, wireless communicating scales being controlled by and reporting weight to the portable controller and indicator.

6. The portable controller and indicator of claim 2, wherein the at least one remote electronic, wireless communicating scale has a 802.14.4 type radio connection or a 900 MHz radio connection.

7. The portable controller and indicator of claim 2 providing a single scale weight and an accumulated scale weight of multiple weighings of at least one remote electronic wireless communication scale on the display.

8. The portable controller and indicator of claim 7, providing total, gross, net, tare and peak weight of at least one remote electronic wireless communicating scale on the display.

9. The portable controller and indicator of claim 7, providing total, gross, net, tare and peak weights of up to four (4) remote electronic wireless communicating scales on the display simultaneously.

10. The portable controller and indicator of claim 1, further comprising a hand holdable housing.

11. The portable controller and indicator of claim 1, wherein the power source comprises at least one battery.

12. The portable controller and indicator of claim 11, further comprising a voltage regulator communicatively connected to the at least one battery, providing approximately 3.3 V power.

13. The portable controller and indicator of claim 1, wherein the radio module is an IEEE 802.15.4 type wireless personal area network (WPAN) radio module.

14. The portable controller and indicator of claim 1, wherein the radio module is a 900 MHZ radio module.

15. The portable controller and indicator of claim 1, wherein microcontroller is a high performance, general purpose 8-bit microcontroller.

16. The portable controller and indicator of claim 1, wherein the display is a 3.3 in graphic LCD display.

17. The portable controller and indicator of claim 1, wherein the display is a 2×16 character LCD display.

18. The portable controller and indicator of claim 1, further comprising a backlight for the display.

19. The portable controller and indicator of claim 1, wherein the keypad includes a Power button, a Zero button, a Accumulated/Total button, a Print button, a Clear button, a Store/Enter button and 0-9 Numeric buttons.

20. A remote weighing system comprising:
a. at least two electronic scales each having a radio module: and
b. a portable controller and indicator for controlling and indicating the weight of the at least two electronic scales, the portable controller and indicator including:
(i) a battery power source,
(ii) a voltage regulator communicatively connected to the battery power source,
(iii) a microcontroller communicatively connected to the voltage regulator,
(iv) a radio module communicatively connected to the microcontroller.
(v) a 3.3 graphic LCD display communicatively connected to the microcontroller, and
(vi) a keypad; and
c. whereby the portable controller and indicator provides at least a single scale weight and an accumulated scale weight of multiple weighings of the at least two remote electronic wireless communication scales on the display simultaneously.

21. The remote weighing system of claim 20:
a. wherein the at least two electronic scales are tension link crane scales each connected to a crane,
b. further comprising a wireless relay control adapted to be communicatively connected to the crane; and
c. whereby the portable controller and indicator is adapted to control the crane.

22. A method of remotely controlling and indicating the weight of an object or article, comprising the steps of:
a. providing at least two electronic scales each having a radio module;
b. providing a portable controller and indicator for controlling and indicating the weight of the at least two electronic scales, the portable controller and indicator including:
(i) a battery power source,
(ii) a voltage regulator communicatively connected to the battery power source,
(iii) a microcontroller communicatively connected to the voltage regulator,
(iv) a radio module communicatively connected to the microcontroller,
(v) a 3.3 graphic LCD display communicatively connected to the microcontroller, and
(vi) a keypad;
c. communicatively coupling at least one object or article to each of scales:
d. weighing the at least one object or article at each scale; and
e. establishing a radio frequency communication link between the using the portable controller and indicator and each scale, whereby the portable controller and indicator provides at least a single scale weight and an accumulated scale weight of multiple weighings of the at least two remote electronic wireless communication scales on the display simultaneously.

23. The method of method of remotely controlling and indicating the weight of an object or article of claim 22:
a. wherein the at least two electronic scales ate tension link crane scales
b. connecting each tension link crane scale to a crane prior to the step of weighing,
c. communicatively connecting a wireless relay to the crane; and
d. controlling the crane via the portable controller and indicator.
